(19) United States
(12) Patent Application Publication
(10) Pub. No.: US 2010/0066505 A1
(43) Pub. Date: Mar. 18, 2010

(54) INFORMATION ACCESS SYSTEM, CONTACTLESS READER AND WRITER DEVICE, AND CONTACTLESS INFORMATION STORAGE DEVICE

(75) Inventors: Shinichi Shiotsu, Kawasaki (JP); Isamu Yamada, Kawasaki (JP); Satoshi Inano, Kawasaki (JP); Akira Itasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/621,262

(22) Filed: Nov. 18, 2009

Related U.S. Application Data
(63) Continuation of application No. PCT/JP07/62862, filed on Jun. 27, 2007.

(51) Int. Cl. H04Q 5/22

(52) U.S. Cl. 340/10.3

(57) ABSTRACT

In a reader and writer device, a sleep period setter determines an identification in a received response, and a length of a sleep period depending on a number of received identifications, a first transmitter transmits either an information request or an information and sleep request carrying the sleep length and the received identification, and a first receiver receives a response carrying an identification. In each of information storage devices, a second receiver senses a carrier, and receives the information request or the information and sleep request in response to carrier detection, and a second transmitter, in response to the information request or the information and sleep request carrying no identification of that device, transmits a response carrying the identification of that device, and, in response to the information and sleep request carrying the identification of that device, is in an inactive state during the sleep time period.

### CROSS-REFERENCE TO RELATED APPLICATION

This application is a U.S. continuation application filed under 35 USC 111(a) claiming benefit under 35 USC 120 and 365(c) of international application PCT/JP2007/62862, filed on Jun. 27, 2007, the entire contents of which are incorporated herein by reference.

### FIELD

A certain aspect of the embodiments discussed herein is related generally to reading and writing information from and into an information storage device in a contactless manner, and in particular to operation of an active-type information storage device to be controlled by a reader and writer device.

### BACKGROUND

An RF ID tag with a battery power supply or of an active type, which may be attached to a merchandise article or the like, or carried by a person, transmits an RF signal at a transmission frequency that carries an ID and other information related to the article or the person, so that the RF signal is received and the information is read out by a reader device. The read-out information is further processed by a computer or the like, so that the distribution of the article or the action of the person is monitored and managed. The active-type RF ID tag with battery power supply has a longer communication range than a passive-type RF ID tag that receives power from a reader and writer device in a contactless manner, and hence is practical in use. However, the active-type RF ID tag transmits an RF signal in a cycle, has a risk of being tracked by a third party, and hence has a problem in the security. To address this security problem, there is an improved active-type RF ID tag that responds only to a tag ID request transmitted by the reader and writer device.

Japanese Laid-open Patent Application Publication JP 2000-113130-A published on Apr. 21, 2000 describes an IC tag detection system with low power consumption. This system includes a plurality of IC tags provided with different set times of day. Each IC tag includes a communication circuit, a control unit, a power source unit for supplying power from a battery to them, and time measuring means. Each IC tag performs transmission at each prescribed set time of day. This system also includes a detector for detecting the presence or absence of the IC tags based on the communication with them. The detector has a communication circuit, and determines the presence or absence of reception from them successively at the respective set times of day of the respective IC tags. Since the IC tag receives no inquiry from the detector, the IC tag can avoid useless reaction and battery consumption.

Japanese Laid-open Patent Application Publication JP 2001-251210-A published on Sep. 14, 2001 describes a method of locking a frequency in a transmitter at each of two nodes in a full duplex link, without using a separate reference oscillator in each node. The method provides locking of transmission frequencies of both nodes in a full duplex link at the same time by utilizing information of a received frequency to tune carrier frequencies of the transmitters. The offset of the carrier frequency of the first transmitter is detected as the offset of a second corresponding receiver. The second receiver shifts the carrier frequency of the second transmitter, in response to the detected offset, to inform the first transmitter about the detected offset. The first receiver uses the detected offset to correct the carrier frequency of the first transmitter.

### SUMMARY

According to an aspect of the embodiment, an information access system includes a reader and writer device and a plurality of information storage devices. The reader and writer device includes a first memory, a first control unit, and a first timing generator for measuring time. The reader and writer device further includes a sleep time period setter unit for determining an identification carried by a response signal received in a period of time, and a length of a sleep period of time depending on a number of received identifications. The reader and writer device further includes a first transmitter unit for repeatedly transmitting either one of an information request signal and an information and sleep request signal carrying a length of the sleep period of time and the received identification, at a first frequency in a time period of transmission. The reader and writer device further includes a first receiver unit for receiving a response signal carrying an identification at a second frequency which is different from the first frequency. Each information storage device includes a second memory for storing an identification of that information storage device, a second timing generator for measuring time, a battery, and a second control unit. Each information storage device includes a second receiver unit for sensing a carrier of an RF signal at the first frequency for detection, and further receiving the information request signal or the information and sleep request signal in response to detection of a carrier of an RF signal. Each information storage device further includes a second transmitter unit for, in response to reception of the information request signal or the information and sleep request signal carrying no identification of that information storage device, transmitting a response signal carrying the identification of that information storage device at the second frequency, and, in response to the reception of the information and sleep request signal carrying the identification of that information storage device, being caused by the second control of the second control unit to be in an inactive state during the sleep period of time.

Other aspects of the embodiment are related to a contactless reader and writer device and a contactless information storage device which may be used for such an information access system. Other aspects of the embodiment are related to programs which may provide such a contactless reader and writer device and such a contactless information storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of configurations of an active-type RF ID tag as an active-type contactless information storage device and of a reader and writer device;

FIG. 2A illustrates an example of a time chart of processing for transmission of an RF signal carrying a tag information request command transmitted by the reader and writer device, FIG. 2B illustrates an example of a time chart of a receive ready state and of processing for reception of a received RF signal in the reader and writer device, and FIG. 2C illustrates an example of a time chart of carrier sensing, processing for reception of received RF signals, and processing for transmission of an RF signal carrying a response in the case of successful authentication, in the active-type RF ID tag;

FIG. 3 illustrates an example of a flow chart for the processing performed by the reader and writer device;

FIGS. 4A and 4B illustrate an example of a flow chart for the processing performed by the active-type RF ID tag;

FIG. 5 illustrates an example of a configuration of an active-type RF ID tag as an active-type contactless information storage device, in accordance with an embodiment of the present invention;

FIGS. 6A and 7A illustrate an example of a time chart of processing for transmission of an RF signal carrying a tag information request command in the reader and writer device, and FIGS. 6B and 7B illustrate an example of a time chart of a receive ready state and of processing for reception of a received RF signal in the reader and writer device;

FIGS. 6C-6H and 7C-7H illustrate an example of time charts of carrier sensing, processing for reception of received RF signals, and processing for transmission of RF signals carrying respective responses, in a plurality of respective active-type RF ID tags;

FIG. 8 illustrates an example of a flow chart for the processing performed by the reader and writer device;

FIGS. 9A and 9B illustrate an example of a flow chart for the processing performed by the active-type RF ID tag;

FIGS. 10A-10C illustrate examples of structures of transmission frames which include respective different commands CMDs to be generated by each data generation unit of each reader and writer device; and

FIG. 11 illustrates an example of a table of the values of a sleep period of time depending on a count of IDs.

### DESCRIPTION OF PREFERRED EMBODIMENTS

Generally, in order to prevent possible collisions among response signals from a plurality of RF ID tags to be received by a reader and writer device or a reader/writer device, each RF ID tag transmits back a response signal at a timing which is determined in accordance with a random number generated by that RF ID tag.

However, an ID request command containing many tag IDs from a reader and writer device causes each RF ID tag to spend a longer time to process the received command, and hence requires more power consumption, which reduces a battery run time of that RF ID tag. In addition, when many RF ID tags are located in a communication range of a reader and writer device, probability of collisions among response signals from several of the RF ID tags may become higher even if each RF ID tag transmits back a response signal at a timing which is determined in accordance with a random number generated by that RF ID tag.

The inventors have recognized that inactivation, for a period of time, of an RF ID tag which corresponds to a tag ID received by a reader and writer device may reduce possible collisions of response signals from other RF ID tags.

It is an object in one aspect of the embodiment to reduce possible collisions between response signals from a plurality of contactless information storage devices.

It is another object in another aspect of the embodiment to reduce power consumption in an active-type contactless information storage device.

According to the aspects of the embodiment, possible collisions between response signals from a plurality of contactless information storage devices can be reduced, and power consumption in an active-type contactless information storage device can be reduced.

Non-limiting preferred embodiments of the present invention will be described with reference to the accompanying drawings. Throughout the drawings, similar symbols and numerals indicate similar items and functions.

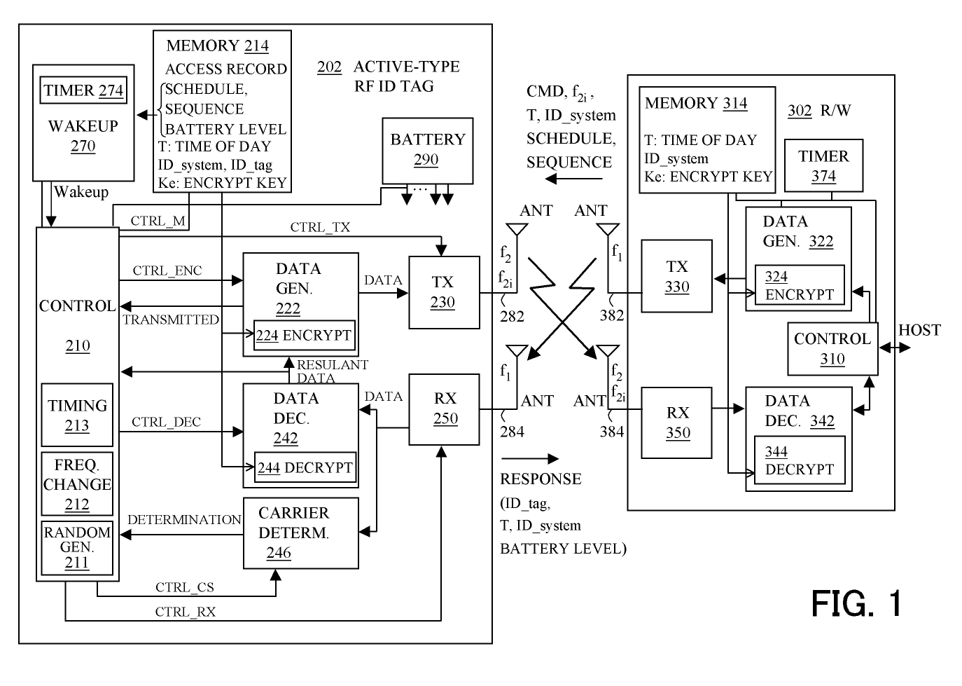

FIG. 1 illustrates an example of configurations of an active-type RF ID tag 202 as an active-type contactless information storage device and of a reader and writer (R/W) device 302. As an active-type contactless information storage device, a contactless IC card having a configuration similar to that of the active-type RF ID tag 202 may be used in place of the active-type RF ID tag 202. In FIG. 1, data transmitted between the RF ID tag 202 and the reader and writer device 302 is encrypted, and the transmitted data is received and decrypted for authentication. Alternatively, authentication may not be performed for the received data, and the transmitted data may not be encrypted.

The active-type RF ID tag 202 includes a control unit 210, a memory 214, a data generation unit 222, a transmitter unit (TX) 230, a receiver unit (RX) 250, a data decoding unit 242, a carrier determination unit 246, a wakeup unit 270, a transmitting antenna (ANT) 282, a receiving antenna (ANT) 284, and a battery 290. The data generation unit 222 encrypts data such as a tag ID (ID_tag) stored in the memory 214, and encodes the encrypted data, to thereby generate encoded data. The transmitter unit (TX) 230 modulates a carrier with the encoded data of a baseband received from the data generation unit 222, and then transmits an RF signal at a frequency f₂ or RF signals at different frequencies f₂ᵢ (i=1, 2, . . . , n). The receiver unit (RX) 250 receives and demodulates an RF signal at a frequency f₁, to thereby reproduce baseband encoded data, and also generates data indicative of the carrier intensity of the received RF signal. The data decoding unit 242 decodes the encoded data received from the receiver unit 250, and decrypts the decoded data to thereby generate decrypted data. The carrier determination unit 246 determines the presence or absence of a received RF signal carrier in accordance with the data indicative of the carrier intensity. The wakeup unit 270 generates a wakeup signal in accordance with a time control sequence, which has been set up beforehand. The transmitting antenna (ANT) 282 is coupled to the transmitter unit 230. The receiving antenna (ANT) 284 is coupled to the receiver unit 250. The battery 290 supplies power to the elements 210-270 and the like of the RF ID tag 202.

The frequencies f₁ and f₂ may be 300 MHz and 301 MHz, respectively, for example. The frequencies f₂ᵢ may be 301 MHz, 302 MHz, . . . , 305 MHz, for example. The transmission output power of the transmitter unit (TX) 230 may be one (1) mW, for example. Alternatively, the antennas 282 and 284 may be integrated into a single antenna.

The control unit 210 includes a random number generator 211, a frequency changing unit 212, and a timing unit 213. The random number generator 211 generates a random number for randomly selecting one of time slots for transmission. The frequency changing unit 212 changes the transmitting frequency f₂ᵢ. The timing unit 213 adjusts a timing for transmission.

The control unit 210 is constantly in an active state after power activation of the RF ID tag 202. The control unit 210 provides a memory control signal CTRL_M, a data generation control signal CTRL_ENC, and a transmission control signal CTRL_TX to the memory 214, the data generation unit 222, and the transmitter unit 230, respectively. The control unit 210 further provides a reception control signal CTRL_RX, and a data decoding control signal CTRL_DEC to the receiver unit 250, and the data decoding unit 242, respectively. The control unit 210 further provides a carrier determination control signal CTRL_CS and a wakeup unit control signal to the carrier determination unit 246, and the wakeup unit 270, respectively. The control unit 210 may be a microprocessor or microcomputer that operates in accordance with a stored program stored in the memory 214.

The memory 214 may store information, such as the tag ID (ID_tag) of the RF ID tag 202, a system ID (ID_system) and an encryption/decryption key Ke for authentication, the current time-of-day information T, and records of accesses performed by the reader and writer device 302. The memory 214 may store further information, such as a control schedule and a time control sequence of the wakeup unit 270, the current remaining power level of the battery 290, a cycle period Ts for sensing a carrier, a time period of processing for reception, and a time period of transmission. The memory 214 provides the current time-of-day information T, the system ID and the encryption/decryption key Ke to the data generation unit 222 and the data decoding unit 242. These pieces of information may be transmitted to the RF ID tag 202 by the reader and writer device 302 beforehand, and then written into the memory 214 by the control unit 210 beforehand. These pieces of information in the memory 214 may be stored and updated under the control of the control unit 210.

The data generation unit 222 includes an encryption unit 224, which encrypts the data to be transmitted, with the encryption key Ke stored in the memory 214 in accordance with a given cryptosystem. The data decoding unit 242 includes a decryption unit 244, which decrypts the received data with the encryption/decryption key Ke in accordance with the given cryptosystem. The system ID is indicative of a common ID shared by a group of the reader and writer device 302 and a plurality of RF ID tags including the RF ID tag 202. The common key cryptosystem is employed as the given cryptosystem herein. Alternatively, the public key cryptosystem may be employed.

The wakeup unit 270 includes a timer 274 which measures time and thereby generates a time of day. The wakeup unit 270 is constantly in an active state after the power activation of the RF ID tag 202. In accordance with the time of day of the timer 274 and with the control schedule and the time control sequence read out from the memory 214 and set up beforehand, the wakeup unit 270 provides a wakeup signal to the control unit 210 in a given cycle Ts for sensing a carrier, for example, of two seconds. The control unit 210 corrects the time of day of the timer 274 in accordance with the current time of day information T in the memory 214, and then writes and updates the current time of day T generated by the timer 274 in the memory 214.

The data generation unit 222 generates data in a given format including the tag ID (ID_tag) stored in the memory 214 and the like, encrypts the generated data in accordance with the given cryptosystem, then encodes the encrypted data in accordance with a given encoding scheme, and then provides the encoded data to the transmitter unit 230. The data may include the remaining battery power level and the access records.

The data decoding unit 242 decodes the received encoded data in accordance with the given encoding scheme, and decrypts the decoded data in accordance with the given cryptosystem. The data decoding unit 242 then provides the decrypted data to the data generation unit 222 and to the control unit 210.

The carrier determination unit 246 receives, from the receiver unit 250, the data indicative of the power intensity of the received RF signal carrier, and accordingly determines the presence or absence of a received carrier. The carrier determination unit 246 then provides the resultant determination to the control unit 210.

The reader and writer device 302 includes a control unit 310, a memory 314, a data generation unit 322, a transmitter unit (TX) 330, a receiver unit (RX) 350, a data decoding unit 342, a timer 374 which measures time and thereby generates a time of day, a transmitting antenna (ANT) 382, and a receiving antenna (ANT) 384. The control unit 310 transmits and receives data to and from a host computer (not shown). The data generation unit 322 generates data in a given format including a command (CMD) and the like received from the control unit 310. The data generation unit 322 then encrypts the generated data, and then encodes the encrypted data, to thereby generate encoded data. The transmitter unit (TX) 330 modulates the carrier with the encoded data of a baseband received from the data generation unit 322, and then transmits an RF signal at the frequency f₁. The receiver unit (RX) 350 receives and demodulates an RF signal at a frequency f₂ or RF signals at frequencies f₂₁-f₂ₙ. The data decoding unit 342 decodes data received from the receiver unit 350 and decrypts the decoded data to thereby generate baseband decrypted data. The receiver unit 350 then provides the decrypted data to the control unit 310. The transmitting antenna (ANT) 382 is coupled to the transmitter unit 330. The receiving antenna (ANT) 384 is coupled to the receiver unit 350. The transmission output power of the transmitter unit (TX) 330 may be 100 mW, for example. Alternatively, the antennas 382 and 384 may be integrated into a single antenna.

The memory 314 of the reader and writer device 302 stores the current time-of-day information T for authentication, the system ID (ID_system) for authentication, and an encryption/decryption key Ke. The data generation unit 322 includes an encryption unit 324, which encrypts the data to be transmitted, with the encryption key Ke stored in the memory 314 in accordance with the given cryptosystem. The data decoding unit 342 includes a decryption unit 344, which decrypts the received data with the encryption/decryption key Ke in accordance with the given cryptosystem.

When the control unit 310 receives a command such as a tag ID or information request command (referred to simply as a tag information request command hereinafter) from the host computer, it provides data including the command to the data generation unit 322. The data may include the transmission frequency f₂ or f₂ᵢ to be used in the RF ID tag 202, the reference current time-of-day information T, and a control schedule and a time control sequence which are new or updated. The command may include an instruction of correcting or updating the time of the timer 274, in addition to the current time-of-day information T. Further, the command may include an instruction of correcting or updating the schedule or the sequence stored in the memory 214, in addition to the control schedule or the time control sequence which are new or updated.

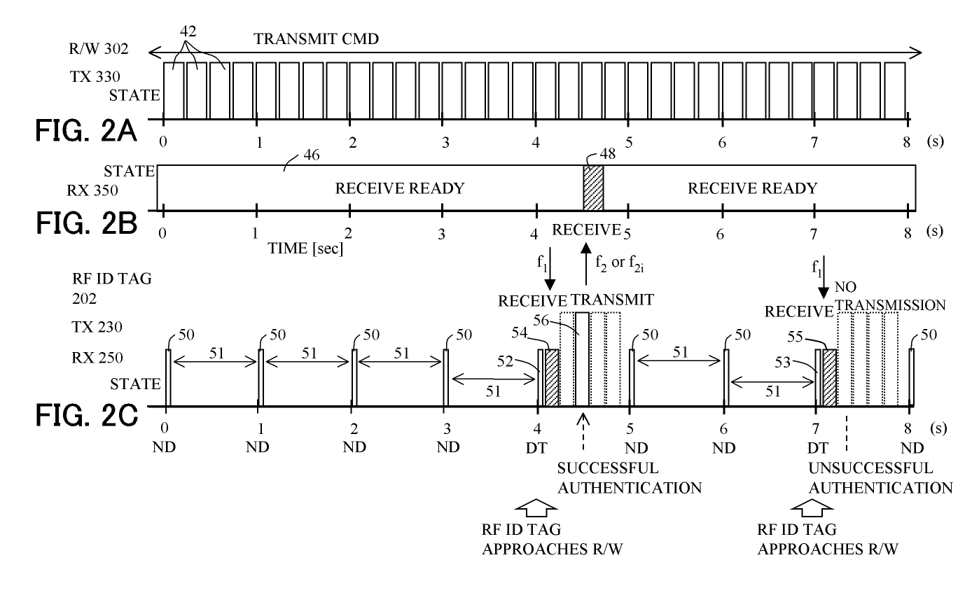

FIG. 2A illustrates an example of a time chart of processing for transmission 42 for an RF signal carrying a tag information request command (CMD) transmitted from the reader and writer device 302. FIG. 2B illustrates an example of a time chart of a receive ready state 46 and of processing for reception 48 of a received RF signal in the reader and writer device 302. FIG. 2C illustrates an example of a time chart of carrier sensing 50, 52 and 53, processing for reception 54 and 55 of received RF signals, and processing for transmission 56 of an RF signal carrying a response in the case of successful authentication, in the active-type RF ID tag 202.

Referring to FIG. 2A, the data generation unit 322 of the reader and writer device 302 generates data including a tag information request command for the RF ID tag that is received from the control unit 310, encrypts the data in accordance with the given cryptosystem, and encodes the encrypted data in accordance with the given encoding scheme to thereby generate encoded encrypted data. The transmitter unit 330 cyclically transmits the RF signal carrying the command in the successive time slots at short intervals in the processing for transmission 42.

Referring to FIG. 2C, in the active-type RF ID tag 202, in response to a wakeup signal from the wakeup unit 274, the receiver unit 250 and the carrier determination unit 246 are enabled in the periods of time for carrier sensing 50 and 52 with a given duration, for example of approximately 1-10 ms, occurring in a particular cycle Ts, for example of two seconds. This causes the receiver unit 250 to enter into a receive ready state. Then the enabled carrier determination unit 246 determines the presence or absence of a received carrier, in accordance with the data received from the receiver unit 250 indicating the power intensity of the received RF signal carrier. When the RF ID tag 202 is not located near the reader and writer device 302, the carrier determination unit 246 detects no carrier (ND), and hence determines the absence of a carrier.

In a period of time 51 intervening between two adjacent carrier sensing time periods 50, the RF ID tag 202 enters into a sleep mode of operation, during which only the control unit 210 and the wakeup unit 270 are enabled or powered on, while the other elements 214-250 are disabled or powered down. The time length Tnslp of the sleep period of time 51 may be shorter than the length of time between the ending time of a carrier sensing time period 50 and the starting time of the next carrier sensing time period 50.

When the RF ID tag 202 approaches the reader and writer device 302 so that the receiver unit 250 of the RF ID tag 202 receives an RF signal, the carrier determination unit 246 detects the carrier of the RF signal (DT) in the time period for carrier sensing 52, and hence determines the presence of a carrier.

In response to the resultant determination of the presence of a carrier, the receiver unit 250 and the data decoding unit 242 are enabled in the time period of the subsequent processing for reception 54 with a given duration, for example, of 100 ms.

The enabled receiver unit 250 receives and demodulates the RF signal to thereby reproduce encoded encrypted data including a command. The enabled data decoding unit 242 decodes the data in accordance with the given encoding scheme, then decrypts the decoded encrypted data with the encryption/decryption key Ke in accordance with the given cryptosystem, then obtains the command from the data, and then provides the command to the control unit 210.

The control unit 210 authenticates the reader and writer device 302 in accordance with the time-of-day information T and the system ID included in the command. When the authentication has been successful, the control unit 210 enables, in response to the command, the data generation unit 222 and the transmitter unit 230 in a time period or slot of processing for transmission 56 selected at random within a given period of time, each time slot having a given duration, for example, of 100 ms.

The enabled data generation unit 222 encrypts, with the encryption key Ke, data including desired information, such as the tag ID (ID_tag), the time-of-day information T, the system ID (ID_system) and the like retrieved from the memory 214, in accordance with the given cryptosystem, and then encodes the encrypted data in accordance with the given encoding scheme. The enabled transmitter unit 230 modulates the carrier with the encoded encrypted response data including the tag ID for transmitting the RF signal.

On the other hand, when the authentication has been unsuccessful, the processing is terminated without generating or transmitting the data.

Referring to FIG. 2B, the receiver unit 350 of the reader and writer device 302 is constantly in the receive ready state 46. When the RF ID tag 202 approaches the reader and writer device 302 so that the receiver unit 350 receives an RF signal, the receiver unit 350 demodulates the received RF signal in the time period of processing for reception 48, and then reproduces encoded encrypted data. The data decoding unit 342 decodes the encoded encrypted data in accordance with the given encoding scheme, then decrypts the decoded encrypted data with the encryption/decryption key Ke in accordance with the given cryptosystem to thereby reproduce the response data including the tag ID, and then provides the reproduced response to the control unit 310. In response to the received and reproduced response, the control unit 310 authenticates the RF ID tag 202 in accordance with the time-of-day information T and the system ID included in the response, and then provides the tag ID to the host computer.

In general, the total time during which the RF ID tag 202 is not located near the reader and writer device 302 is much longer than the time during which the RF ID tag 202 is located near the reader and writer device 302. Thus, the active-type RF ID tag 202 is in a sleep mode of operation for the most period of time. This significantly reduces the power consumption of the active-type RF ID tag 202, and hence significantly increases the run time of the battery 290.

In general, when the reader and writer device 302 and the RF ID tag 202 encrypt the data to be transmitted and perform mutual authentication in accordance with the time-of-day information T and the system ID, the data transmitted by the reader and writer device 302 and the RF ID tag 202, which may be intercepted by a third party, has little risk of being decrypted and used improperly. This enhances the security of the reader and writer device 302 and the RF ID tag 202.

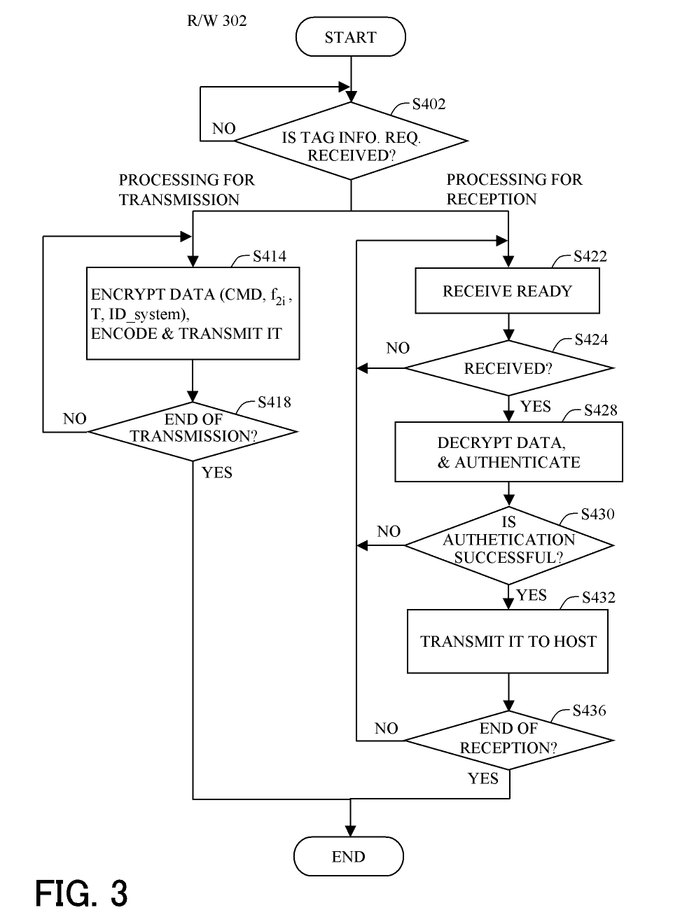

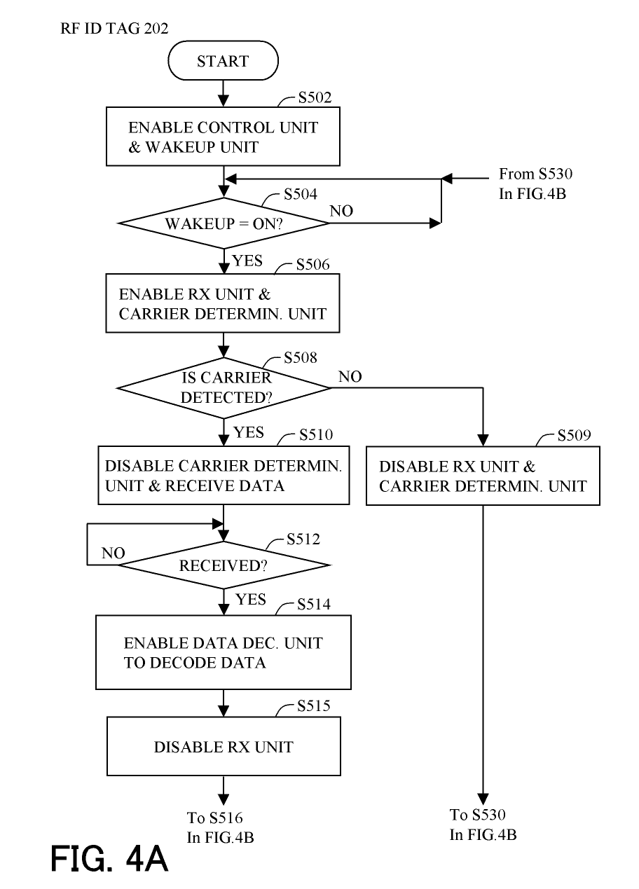

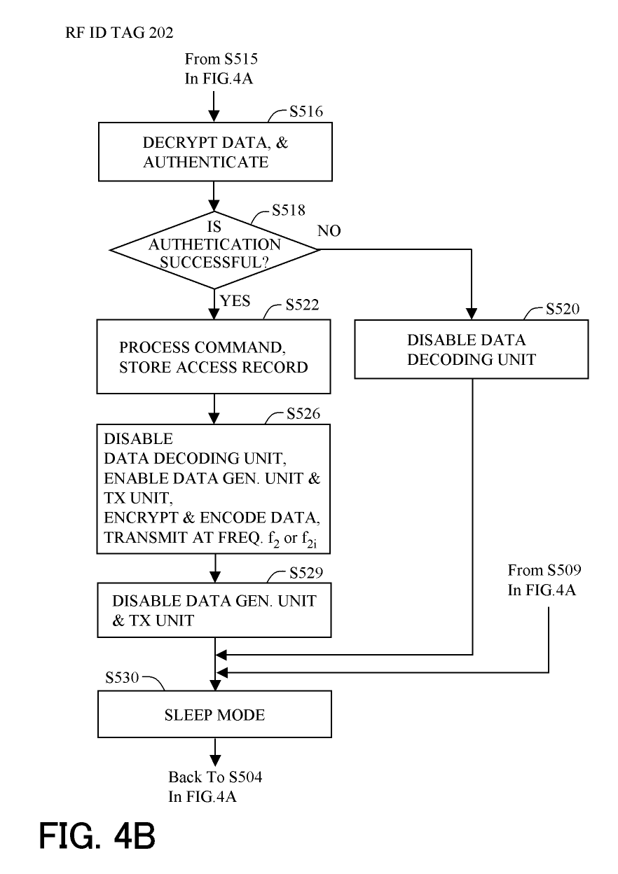

FIG. 3 illustrates an example of a flow chart for the processing performed by the reader and writer device 302. FIGS. 4A and 4B illustrate an example of a flow chart for the processing performed by the active-type RF ID tag 202.

Referring to FIG. 3, at Step 402, the control unit 310 of the reader and writer device 302 determines whether a tag information request command received from the host computer has been detected. Step 402 is repeated until a tag information request command is detected. When a tag information request command is detected, the procedure proceeds to Step 414 for processing for transmission and to Step 422 for processing for reception.

At Step 414, the control unit 310 provides the tag information request command and the related information to the data generation unit 322. The data generation unit 322 encrypts data including the tag information request command received from the control unit 310 and including the current time-of-day information T and the system ID (ID_system) retrieved from the memory 314, with the encryption key Ke retrieved from the memory 314 in accordance with a given cryptosystem. The given cryptosystem may be the DES (Data Description Standard), the Triple DES or the AES (Advanced Encryption Standard), for example. The data generation unit 322 then encodes the encrypted data in accordance with a given encoding scheme, such as the NRZ (Non-Return-to-Zero) encoding system or the Manchester encoding system. In the time period of processing for transmission 42, the transmitter unit 330 modulates the carrier with the encoded data of FIG. 2A, and then transmits the RF signal at a frequency f₁.

The control unit 310 may incorporate, into the tag information request command, data for specifying the transmission frequency f₂ or the variable transmission frequencies f₂ᵢ used for a response to the tag information request command, and data indicative of time of day or time slots to be used for the variable transmission frequencies f₂ᵢ as well as data indicative of the current time of day T, and a control schedule and a time control sequence.

The reader and writer device 302 may change the frequencies f₂ᵢ in a time division manner, selecting one of the frequencies for every set of commands in respective transmission cycles t_{RW-CY}, (the number of which may correspond, for example, to the time length of one or more cycles for sensing a carrier). This reduces the probability of collision between response RF signals transmitted from a plurality of RF ID tags which simultaneously approach the reader and writer device 302. This increases the number of RF ID tags that the reader and writer device 302 can simultaneously identify.

At Step 418, the control unit 210 determines whether the processing for data transmission is to be terminated. If it is determined that the data transmission is to be terminated, the procedure exits this routine. If it is determined that the processing for data transmission is to be continued, the procedure returns to Step 414. In FIG. 2A, the data transmission is repeated and continued.

Referring to FIG. 4A, at Step 502, when the RF ID tag 202 is activated, the control unit 210 and the wakeup unit 270 are enabled. Once the RF ID tag 202 is activated, the control unit 210 and the wakeup unit 270 are constantly enabled, and hence in an active state. In accordance with the timer 274 and with the time control sequence, the wakeup unit 270 provides the control unit 210 with a wakeup signal indicative of the timing for carrier sensing of a received RF signal in a given cycle Ts. At Step 504, the control unit 210 determines whether the wakeup signal received from the wakeup unit 270 indicates an ON state. The control unit 210 repeats the Step 504 until the wakeup signal goes to the ON state.

If it is determined at Step 504 that the wakeup signal indicates the ON state, then the control unit 210 at Step 506 enables the receiver unit 250 and the carrier determination unit 246 for a time period with a short duration, for example, of approximately 1-10 ms. Then, the enabled receiver unit 250 enters into the state of being ready to receive an RF signal. In accordance with the data received from the receiver unit 250 that is indicative of the received carrier power, the enabled carrier determination unit 246 determines the presence or absence of a received RF signal carrier, and then provides the resultant determination to the control unit 210. At Step 508, in accordance with the resultant determination, the control unit 210 determines whether a carrier is detected. If it is determined that no carrier is detected, the control unit 210 at Step 509 disables the receiver unit 250 and carrier determination unit 246. After that, the procedure proceeds to Step 530.

If it is determined at Step 508 that a carrier is detected, then the control unit 210 at Step 510 disables carrier determination unit 246 and continues to enable the receiver unit 250 in a further given duration, for example of 100-200 ms, to receive an RF signal at a frequency f₁ carrying a command from the reader and writer device 302 (reception 54 in FIG. 2C), and then demodulates the received RF signal. At Step 512, the control unit 210 determines whether the receiver unit 250 has received the RF signal. The Step 512 is repeated until the reception of the RF signal is completed.

If it is determined at Step 512 that the RF signal has been received, then the control unit 210 at Step 514 enables the data decoding unit 242. The enabled data decoding unit 242 receives the received data from the receiver unit 250 under the control of the control unit 210, and then decodes the data in accordance with the given encoding scheme. At Step 515, the control unit 210 disables the receiver unit 250.

Referring to FIG. 4B, at Step 516, under the control of the control unit 210, the data decoding unit 242 decrypts the decoded data with the encryption/decryption key Ke retrieved from the memory 214 in accordance with the given cryptosystem, and then provides the decrypted data including the command, the tag ID (ID_tag), the time-of-day information T, and the system ID (ID_system) to the control unit 210. The data may include a control schedule and a time control sequence. Upon receiving the data, the control unit 210 compares the decrypted time-of-day T and system ID with the stored time-of-day T and system ID in the memory 214, to determine whether the decrypted time information and ID match with the stored time information and ID, in order to authenticate the reader and writer device 302.

At Step 518, the control unit 210 determines whether the authentication has been successful. If it is determined that the authentication has been unsuccessful, the control unit 210 at Step 520 disables the data decoding unit 242. Then, the procedure proceeds to Step 530.

If it is determined at Step 518 that the authentication has been successful, the control unit 210 at Step 522 receives the decrypted decoded data including the tag information request command from the data decoding unit 242, then processes the received command included in the decrypted data, and then stores into the memory 214 the record of access performed by the reader and writer device 302.

When a time correction command and the current time-of-day information T are included in the received data, the control unit 210 corrects or updates the time of the timer 274 of the wakeup unit 270 into the time T.

At Step 526, in accordance with the tag information request command, the control unit 210 enables the data generation unit 222 and the transmitter unit 230 in a time slot selected at random in accordance with a random number from a given number of time slots within a given period of time. This selected time slot corresponds to the time period of the processing for transmission 56 of FIG. 2C.

The data generation unit 222 encrypts data including the tag ID (ID_tag) of the RF ID tag 202, the time-of-day information T, and the system ID (ID_system) read out from the memory 214, with the encryption key Ke in accordance with the given cryptosystem. The data generation unit 222 then encodes the encrypted data in accordance with the given encoding scheme, and then provides the encoded encrypted data to the transmitter unit 230.

The enabled transmitter unit 230 modulates the carrier with the encoded encrypted data, and then transmits the RF signal at a frequency f₂ or f₂ᵢ via the antenna 284 (transmission 56 in FIG. 2C). The frequency f₂ᵢ is changed by the frequency changing unit 212 of the control unit 210. The timing unit 213 adjusts a plurality of successive cycle time slots to occur in a given cycle.

At Step 529, the control unit 210 disables the data generation unit 222 and the transmitter unit 230. At Step 530, the control unit 210 causes the RF ID tag 202 to enter into the sleep mode of operation. In the sleep mode of operation, basically, only the control unit 210 and the wakeup unit 270 continue to stay in the enabled state, while the other elements 214-250 are disabled.

Referring back to FIG. 3, at Step 422, the control unit 310 enables the receiver unit 350 to enter into the receive ready state. The receiver unit 350 waits for the reception of an RF signal at a frequency f₂ (receive ready 46), and then receives an RF signal (processing for reception 48). At Step 424, the control unit 310 determines whether the receiver unit 350 has received the RF signal. Steps 424-424 are repeated until the reception is completed. If it is determined that the RF signal has been received, the procedure proceeds to Step 428.

At Step 428, the receiver unit 350 provides the received data to the data decoding unit 342. The data decoding unit 342 decodes the received data in accordance with the given encoding scheme, then decrypts the decoded data in accordance with the given cryptosystem, and then provides the determination of data reception and the decrypted data to the control unit 310. The control unit 310 compares the decrypted time T and system ID with the stored time T and system ID in the memory 314, to determine whether the decrypted time information and ID match with the stored time information and ID, in order to authenticate the RF ID tag 202. Even if there is an error between the received time-of-day information T and the stored time-of-day information T that falls within a tolerable range (e.g., ±0.5 seconds) in the control unit 210 of the RF ID tag 202 and in the control unit 310 of the reader and writer device 302, they may determine that the received time-of-day information matches with the stored time-of-day information.

At Step 430, the control unit 310 determines whether the authentication has been successful. If it is determined that the authentication has been unsuccessful, the procedure returns to Step 422. If it is determined that the authentication has been successful, the procedure proceeds to Step 432.

At Step 433, the control unit 310 transmits the decoded data to the host computer. At Step 436, the control unit 310 determines whether the data receive ready state is to be terminated. If it is determined that the data receive ready state is to be terminated, the procedure exits the routine of FIG. 3. If it is determined that the data receive ready state is to be continued, the procedure returns to Step 422. In FIG. 2B, the data receive ready state is repeated and continued.

Thus, the reader and writer device 302 transmits the RF signal cyclically at sufficiently short intervals, and is constantly in the ready state to receive the RF signal. This significantly reduces the carrier sensing time of the RF ID tag 202. Thus, when the transmission and reception take place only several times a day, for example, for entry and exit control, the most operating time is used for carrier sensing, and hence the entire power consumption of the RF ID tag 202 can be reduced significantly.

In a control schedule stored in the memory 214, the holidays and a period of time between a time point and another time point in the night-time (e.g., 6:00 pm to 6:00 am) of the weekdays may be specified, while a period of time between a time point and another time point in the daytime (e.g., 6:00 am to 6:00 pm) of the weekdays may be specified. In this case, the wakeup unit 270 generates no wakeup signal on the holidays and in the night-time, i.e., the RF ID tag 202 is in a sleep mode of operation, and does not perform carrier sensing at all. In contrast, it performs carrier sensing in a given cycle (e.g., of one second) in the daytime of the weekdays.

Under the control of the control unit 210, the wakeup unit 270 may generate a wakeup signal depending on the remaining power level P of the battery 290 stored in the memory 214. In this case, when the remaining battery power level P is sufficiently high, the carrier sensing may be performed in a relatively short cycle (e.g., of one second). On the other hand, when the remaining battery power level P goes below a threshold Pth, the carrier sensing may be performed in a relatively long cycle (e.g., of two seconds). Further, data representative of the remaining battery power level P may be incorporated into the response data of the RF ID tag 202, and then provided to the host computer via the reader and writer device 302, so that the host computer displays a warning of battery run-out to a user.

When the records of accesses performed by the reader and writer devices are stored as a log of accesses in the memory 214 as described above, even an unauthorized access performed by a reader and writer device other than the reader and writer device 302 can be recorded as the log. Thus, when the log of accesses is read by the reader and writer device 302 and then analyzed by the host computer, the unauthorized access can be recognized.

The configurations and operations of the active-type RF ID tag 202 and the reader and writer device 302 described above are partly disclosed in the US Patent Application Publication No. 2006/276206-A1 (which corresponds to Japanese Laid-open Patent Application Publication No. JP 2006-338489-A), the entirety of which is incorporated herein by reference.

In general, in order for a reader and writer 302 to receive response signals from a plurality of RF ID tags 202 without collisions between such response signals, each RF ID tag 202 transmits a response signal back to the reader and writer device at a timing determined in accordance with a random number generated in that RF ID tag 202.

However, when a tag ID request command CMD transmitted from the reader and writer device 302 to the RF ID tags contains data of a number of different tag IDs, each RF ID tag 202 requires a long time in the processing for reception. Thus, excessive battery power is consumed, and hence the battery run time is reduced. Further, when a number of RF ID tags 202 are located in the communication range of the reader and writer device 302, each RF ID tag 202 transmits a response signal back to the reader and writer device 302 at a timing determined in accordance with a random number generated within that RF ID tag 202. However, there may be high probability of collision between any ones of the response signals from the number of RF ID tags 202 may occur.

The inventors have recognized that a reader and writer device can control an RF ID tag which corresponds to a tag ID carried by a response signal received successfully by the reader and writer device into an inactive or sleep state in a subsequent particular period or until the reader and writer device receives response signals of a majority of the RF ID tags, so that the probability of collision between the response signal and the other response signals from the other RF ID tags can be reduced.

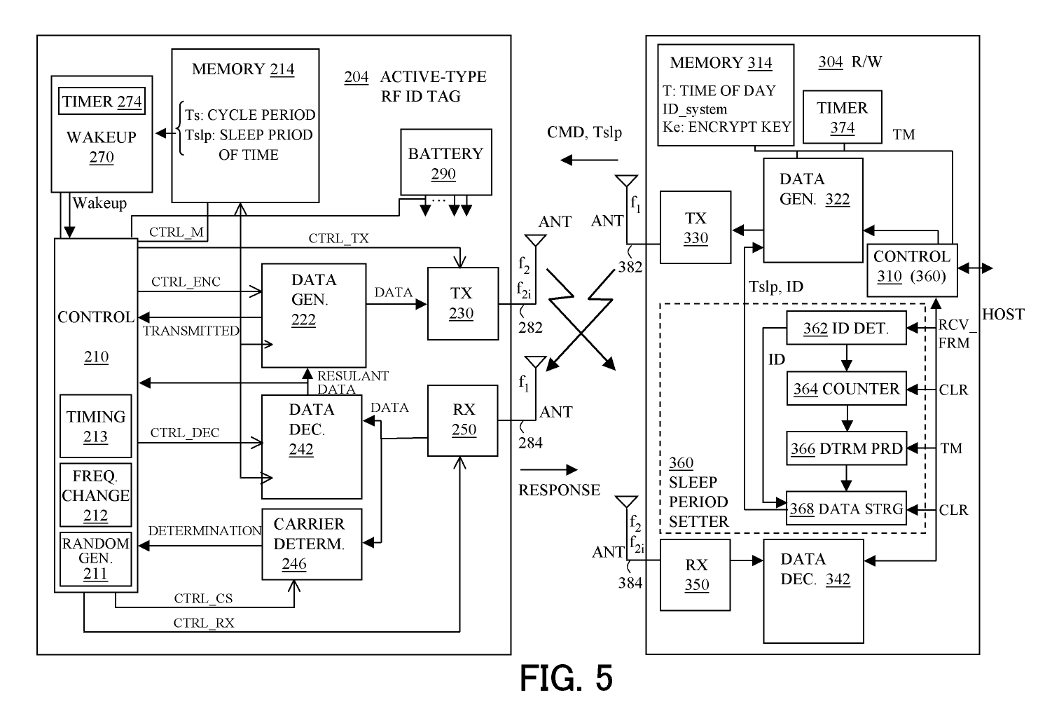

FIG. 5 illustrates an example of configurations of an active-type RF ID tag 204 as an active-type contactless information storage device and of a reader and writer (R/W) device 304, in accordance with an embodiment of the invention. The RF ID tag 204 and the reader and writer device 304 are modifications of the RF ID tag 202 and the reader and writer device 302 of FIG. 1, respectively.

In the RF ID tag 204, the control unit 210 receives data representative of a sleep period of time Tslp from the reader and writer 304, then stores the data into the memory 214, and then controls the wakeup unit 270 to set the sleep period of time Tslp into the timer 274. The sleep period of time Tslp is independent of the cycle period Ts for sensing a carrier. In the set sleep period of time Tslp, the control unit 210 controls the RF ID tag 204 to enter into a sleep mode of operation and to stop the operations of carrier sensing and of transmission and reception. The other elements of the RF ID tag 204 are similar to those of the RF ID tag 202 of FIG. 1, and hence are not described again.

The elements 222-246 and 270 may be implemented in the form of hardware as separate circuits or portions of the control unit 210. Alternatively, at least a part of the elements 222-246 and 270 may be implemented in the form of software as functions of the control unit 210 which operate according to a program stored in the memory (214).

The reader and writer 304 further includes a sleep time period setter unit 360 coupled to the control unit 310 and the data generation unit 322. The other elements of reader and writer device 304 are similar to those of the reader and writer device 302 of FIG. 1.

The elements 322, 342 and 360 may be implemented in the form of hardware as separate circuits or portions of the control unit 210. Alternatively, at least a part of the elements 322, 342 and 360 may be implemented in the form of software as functions of the control unit 310 which operate according to a program stored in the memory (314).

The sleep time period setter unit 360 includes an ID detector unit 362 which detects and extracting a tag ID from the data of a frame RCV_FRM received from an RF ID tag, and a counter 364 which counts the number of received different tag IDs. The sleep time period setter unit 360 further includes a sleep time period determiner unit 366 which determines a sleep period of time Tslp corresponding to the count number of tag IDs, and a data hold unit 368 which holds the received tag IDs and the determined sleep period of time Tslp. The data hold unit 368 may be a memory area in the memory 314 for holding data.

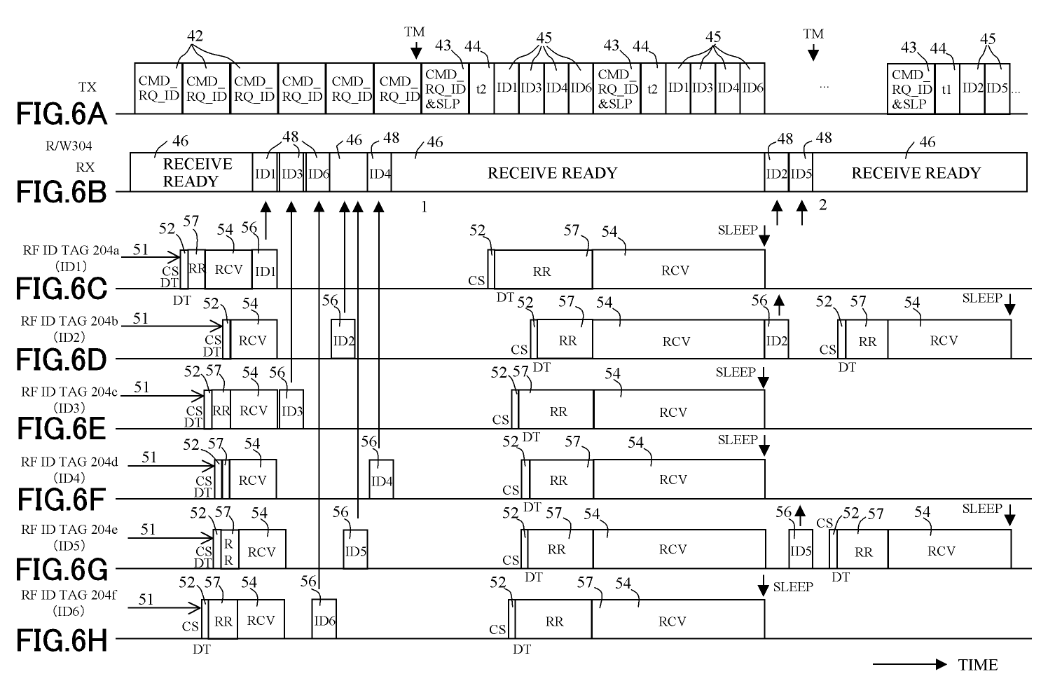

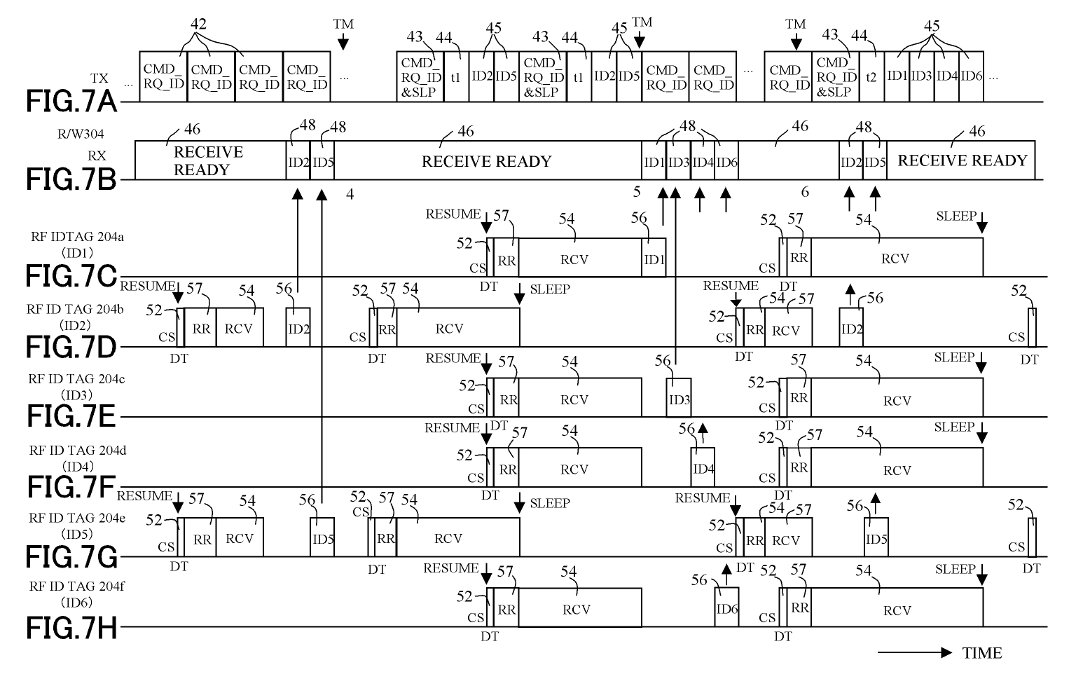

FIGS. 6A and 7A illustrate an example of a time chart of processing for transmission 42, and 43-45 of an RF signal carrying a tag information request command (CMD), in the reader and writer device 304. FIGS. 6B and 7B illustrate an example of a time chart of a receive ready state 46 and of processing for reception 48 of a received RF signal, in the reader and writer device 304. FIGS. 6C to 6H and 7C to 7H illustrate an example of time charts of carrier sensing 52, processing for reception 54 of received RF signals, and processing for transmission 56 of RF signals carrying respective responses, in a plurality of respective active-type RF ID tags 204a to 204f.

Referring to FIG. 6A, when the reader and writer device 304 does not require an RF ID tag to operate in a sleep state, the data generation unit 322 of the reader and writer device 304 generates data including the command (CMD_RQ_ID) described above which is similar to that of FIG. 2A. When the reader and writer device 304 requires an RF ID tag to operate in a sleep state, the data generation unit 322 generates data including a command (CMD_RQ_ID&SLP) representative of both of a request for sleep to the RF ID tag 204 having the tag ID received from the sleep time period setter unit 360 and an normal tag information request. The data generation unit 322 encrypts the data in accordance with the given cryptosystem, and then encodes the encrypted data in accordance with the given encoding scheme, to generate encoded encrypted data. In successive time slots 42 or 43 to 45 of processing for transmission, the transmitter unit 330 transmits repeatedly at sufficiently short intervals an RF signal carrying the command (CMD_RQ_ID or CMD_RQ_ID&SLP).

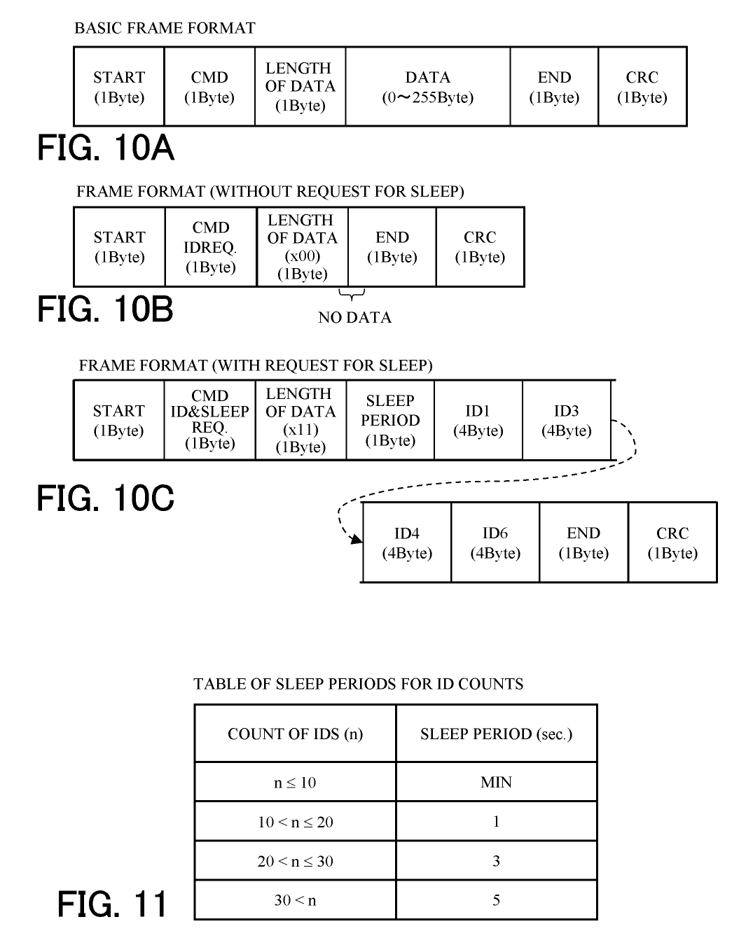

FIGS. 10A-10C illustrate examples of formats of transmission frames which include respective different commands CMDs to be generated by the data generation unit 322 of the reader and writer devices 304.

In FIG. 10A, a basic format of the transmission frame may include fields for a start (one byte), a command (CMD) (one byte), a length of data (one byte), variable-length data (0 to 255 bytes), an end (one byte), and a check (one byte).

In FIG. 10B, a format of the transmission frame for requesting a tag ID without a request for a sleep may include fields for a start (one byte), a command (CMD) (one byte) indicative of a tag ID request, a length of data (one byte), variable-length data (zero to 255 bytes), an end (one byte), and a check (one byte).

In FIG. 10C, a format of the transmission frame for requesting a tag ID and a sleep may include fields for a start (one byte), a command (CMD) (one byte) indicative of a tag ID request and a request for a sleep, a length of data (one byte), a sleep period of time Tslp (one byte), tag IDs for the number of received tag IDs (four bytes for each tag ID), an end (one byte), and a check (one byte).

Referring to FIGS. 6C to 6H, in each of the active-type RF ID tags 204a to 204f, the receiver unit 250 and the carrier determination unit 246 are enabled by the control unit 210 in a time period of carrier sensing 52 generated in a cycle period Ts such as 0.6 seconds, 0.8 seconds or 1 second with a duration of, for example, approximately 1 ms to 10 ms in accordance with a wakeup signal from the wakeup unit 274. Thus, the receiver unit 250 enters into a receive ready state, and the carrier determination unit 246 determines the presence or absence of a received carrier (CS) in accordance with data received from the receiver unit 250 indicating the power intensity of the received RF signal carrier.

When the RF ID tags 204a to 204f approach the reader and writer device 304 almost simultaneously so that the receiver unit 250 of each RF ID tag 204 receives an RF signal, the carrier determination unit 246 in a time period of carrier sensing 52 detects the carrier of an RF signal (DT) to determine the presence of a carrier. In response to the determination of the presence of a carrier, the receiver unit 250 and the data decoding unit 242 are enabled in the subsequent time period of a receive ready state (RR) 57 and/or the subsequent time period of processing for reception (RCV) 54, while the receiver unit 250 maintains to be in a receive ready state. Further, in the time period of processing for reception 54, the receiver unit 250 receives and demodulates the RF signal to thereby reproduce encoded encrypted data including the command. The enabled data decoding unit 242 decodes the data in accordance with the given encoding scheme, then decrypts the decoded encrypted data with encryption/decryption key Ke in accordance with the given cryptosystem, then obtains the command from the data, and then provides the command to the control unit 210.

In response to the command, the control unit 210 enables the data generation unit 222 and the transmitter unit 230 in a time period or slot of processing for transmission 56 selected at random within a given period of time. The enabled data generation unit 222 encrypts data including desired information, such as the tag ID (ID_tag), the time-of-day information T, the system ID (ID_system) and the like retrieved from the memory 214, in accordance with the given cryptosystem, and then encodes the encrypted data in accordance with the given encoding scheme. The desired information may include other information, such as commodity contents of a package and the number and state of the content items, a sender, transportation, a route and a destination. The enabled transmitter unit 230 modulates the carrier with the encoded encrypted response data including the encrypted tag ID for transmitting the RF signal.

Referring to FIG. 6B, the receiver unit 350 of the reader and writer device 304 is constantly in a receive ready state 46. When the RF ID tags 204a to 204f approach the reader and writer device 304, the receiver unit 350 receives the RF signals. In this case, the tag IDs ID1, ID3, ID4 and ID6 of the respective RF ID tags 204a, 204c, 204d and 204f are received normally. However, the RF signals carrying tag IDs ID2 and ID5 of the respective RF ID tags 204b and 204e collide with each other and hence are not received normally.

In the time period of processing for reception 48, the receiver unit 350 demodulates the received RF signals to thereby generate encoded encrypted data. The data decoding unit 342 decodes the encoded encrypted data in accordance with the given encoding scheme, then decrypts the decoded decrypted data in accordance with the given cryptosystem to thereby reproduce the response data including the tag IDs (ID1, ID3, ID4 and ID6). The data decoding unit 342 then provides the reproduced response to the control unit 310. The control unit 310 provides the response data to the sleep time period setter unit 360 and the host computer. The sleep time period setter unit 360 may receive the response data from the data decoding unit 368. The host computer processes the tag ID for use in monitoring and managing the article distribution or the persons.

The ID detector 362 of the sleep time period setter unit 360 detects and extracts tag IDs from the response data received from the control unit 310 or the data decoding unit 342, and then provides the extracted tag IDs to the counter 364 and the data hold unit 368. Alternatively, the control unit 310 may extract the tag IDs from the response data and then provide the tag IDs to the counter 364 and the data hold unit 368 of the sleep time period setter unit 360. The counter 364 counts the number of received different tag IDs exclusively without overlap. The sleep time period determiner unit 366 determines the value of a temporary long sleep period of time Tslp in accordance with the number of tag IDs received from the counter 364 and with a particular formula or a table for determining a sleep period of time at a cyclic timing TM. The cyclic timing TM has a cycle period of, for example, 1 second generated by the timer 374. The sleep time period determiner unit 366 provides the determined value Tslp to the data hold unit 368. The particular formula may be, for example, Tslp=INT[(the number of received IDs)/C]×Ts′ (where INT[ . . . ] represents an integer part of the number of received IDs divided by C), where C is a constant of natural number such as 5, 6 and 7 depending on the number of the RF ID tags. The unit time Ts′ has a value equal to Ts or smaller. Thus, Ts′=m×Ts, where m is a value, such as 0.5, which is smaller than or equal to one. The unit time Ts′ may be determined as Ts′=Ts. The data hold unit 368 holds the sleep period of time Tslp and the tag IDs.

FIG. 11 illustrates an example of the table of the values of the sleep period of time Tslp depending on the count of IDs. In this case, when the count is ten (10) or smaller, the sleep period of time Tslp is set to be zero (0) second or a normal minimum value MIN (e.g., 0.5 seconds). When the count is between 11 and 20 inclusive, the sleep period of time Tslp is set to be one (1) second. When the count is between 21 and 30 inclusive, the sleep period of time Tslp is set to be two (2) seconds. When the count is greater than 30, the sleep period of time is set to be three (3) seconds.

When tag IDs and the value of sleep period of time Tslp are held in the data hold unit 368, the control unit 310 provides a request for tag information (tag ID) and sleep to the data generation unit 322. The data generation unit 322 generates a command for requesting tag information and sleep CMD (CMD_RQ_ID&SLP) corresponding to the request received from the control unit 310. The control unit 310 then concatenates, with the command CMD, the value (t2 or t1) of the sleep period of time Tslp retrieved from the data hold unit 368 and the tag IDs (ID1, ID3, ID4 and ID6) received normally so as to generate transmission data, then encrypts the data, and then encodes the encrypted data, were it is assumed that the value of the sleep period of time Tslp is t2=3 seconds. The command includes a tag information request and a sleep request. In the successive time slots 43 to 45 in the processing for transmission 42 and for a particular number of times or for a particular period of time, the transmitter unit 330 repeatedly transmits an RF signal carrying the transmission data at sufficiently short intervals. After that, the data generation unit 322 resumes the repeated transmission of an RF signal carrying the data including the tag information request command (CMD_RQ_ID).

After the next carrier sensing period 52, each of the RF ID tags 204a, 204c, 204d and 204f maintains to be in a receive ready state in the time period 57. In the time period of processing for reception (RCV) 54, each of the RF ID tags 204a, 204c, 204d and 204f receives data including the command (CMD_RQ_ID&SLP), the value of the sleep period of time Tslp (t2), and the tag IDs (ID1, ID3, ID4 and ID6), and then stores the data into the memory 214. In response to the reception of the data, the control unit 210 in each of the RF ID tags 204a, 204c, 204d and 204f sets the value t2 into the timer 274 as a temporary sleep period of time Tslp of that RF ID tag, and then enters into a sleep mode of operation in the period of time t2, to inactivate the transmission and the carrier sensing CS. In this case, the start time of measuring the sleep period of time t2 is the start time of receiving the command. Alternatively, the start time of measuring may be the time of actual entry into a sleep mode.

On the other hand, the receiver unit 250 of each of the RF ID tags 204b and 204e maintains to be in a receive ready state in the time period 57, and then receives the RF signal carrying the data including the tag information request command (CMD_RQ_ID&SLP) in the time period of processing for reception (RCV) 54. The data decoding unit 242 decodes the data to extract the data including the command, and then provides the data to the control unit 210. The received data does not contain the tag ID of the RF ID tags 204b and 204e. In response to the command, the control unit 210 enables the data generation unit 222 and the transmitter unit 230 in a time period of processing for transmission 56 selected at random within a particular period of time. The enabled data generation unit 222 generates and encodes data including the tag ID (ID2 or ID5) and the other desired information. The transmitter unit 230 modulates the carrier with the response data including the tag ID, and then transmits an RF signal.

In this case, the receiver unit 350 of the reader and writer device 304 normally receives the tag IDs (ID2 and ID5) of the RF ID tags 204b and 204e. In response to the cyclic timing signal TM from the timer 374, the sleep time period determiner unit 366 of the sleep time period setter unit 360 determines the value of the temporary sleep period of time Tslp in accordance with the number (2, in this example) of tag IDs received from the counter 364 and with the particular formula or the table for determining a sleep period of time. The data hold unit 368 holds the sleep period of time Tslp and the tag IDs. The cycle period of the timing signal TM may be equal to the cycle period Ts for sensing a carrier. Thus, in the cycle Ts for sensing a carrier, each of the tag IDs carried by potentially receivable response signals from all of the RF ID tags 204a to 204f can be received only once without overlap.

The data generation unit 322 generates a command of requesting tag information and sleep CMD (CMD_RQ_ID&SLP) corresponding to the request received from the control unit 310, then concatenates with the command CMD the value (t1) of the sleep period of time Tslp retrieved from the data hold unit 368 and the normally received tag IDs (ID2 and ID5) to thereby generate transmission data, then encrypts the data, and then encodes the encrypted data, where it is assumed that the value of the sleep period of time Tslp is equal to t1=1 second. In the successive time slots 43 to 45 in the processing for transmission 42, for a particular number of times or for a particular period of time, the transmitter unit 330 repeatedly transmits an RF signal carrying the transmission data at sufficiently short intervals. After that, the data generation unit 322 resumes the repeated transmission of an RF signal carrying the data including the tag information request command (CMD_RQ_ID).

After the next carrier sensing period 52, each of the RF ID tags 204b and 204e maintains to be in a receive ready state in the time period 57. In the time period of processing for reception (RCV) 54, each of the RF ID tags 204b and 204e receives data including the command (CMD_RQ_ID&SLP), the value of the sleep period of time Tslp (t2), and the tag IDs (ID2 and ID5), and then stores the data into the memory 214. In response to the reception of the data, the control unit 210 of each of the RF ID tags 204b and 204e sets the value t1 into the timer 274 as the temporary sleep period of time Tslp, and then enters into a sleep mode of operation in the period of time t1, to inactivate the carrier sensing CS.

Referring to FIGS. 7C to 7G, when the sleep period of time Tslp=t1 has elapsed, the RF ID tags 204b and 204e resumes or return to a normal mode of operation from the sleep mode of operation. The RF ID tags 204b and 204e receive the command (CMD_RQ_ID) from the reader and writer device 304 in the time period of processing for reception 54, and then transmit back the tag IDs (ID2 and ID5) in a randomly determined time period of transmission 56. In response, the reader and writer device 304 transmits to the RF ID tags 204b and 204e an RF signal carrying the data including the command (CMD_RQ_ID&SLP) described above, the value of the sleep period of time Tslp (t2), and the tag IDs (ID2 and ID5). The RF ID tags 204b and 204e receive the RF signal, and then again enter into a sleep mode of operation in the determined sleep period of time Tslp (t2).

On the other hand, when the sleep period of time Tslp=t2 has elapsed, the RF ID tags 204a, 204c, 204d and 204f resumes the normal mode of operation from the sleep mode of operation. The RF ID tags 204a, 204c, 204d and 204f receive the command (CMD_RQ_ID) from the reader and writer device 304 in the time period of processing for reception 54, and then transmit back the tag IDs (ID1, ID3, ID4 and ID6) in a randomly determined time period of transmission 56. After that, the reader and writer device 304 and the RF ID tags 204a to 204f operate in a similar manner.

Thus, as the number of tag IDs received within the same time period is larger, the reader and writer device 304 sets those RF ID tags into a sleep mode of operation for a longer time period. This causes RF ID tags which have been read out by the reader and writer device to be disabled from the carrier sensing until reading of almost all RF ID tags is completed. This prevents interference of already read-out RF ID tags with the other RF ID tags yet to be read. When the sleep period of time Tslp has elapsed and all of the RF ID tags have been read, all of the RF ID tags may be caused to resume the normal mode of operation, preferably at approximately the same time, in order to allow another reader and writer device to read the RF ID tags.

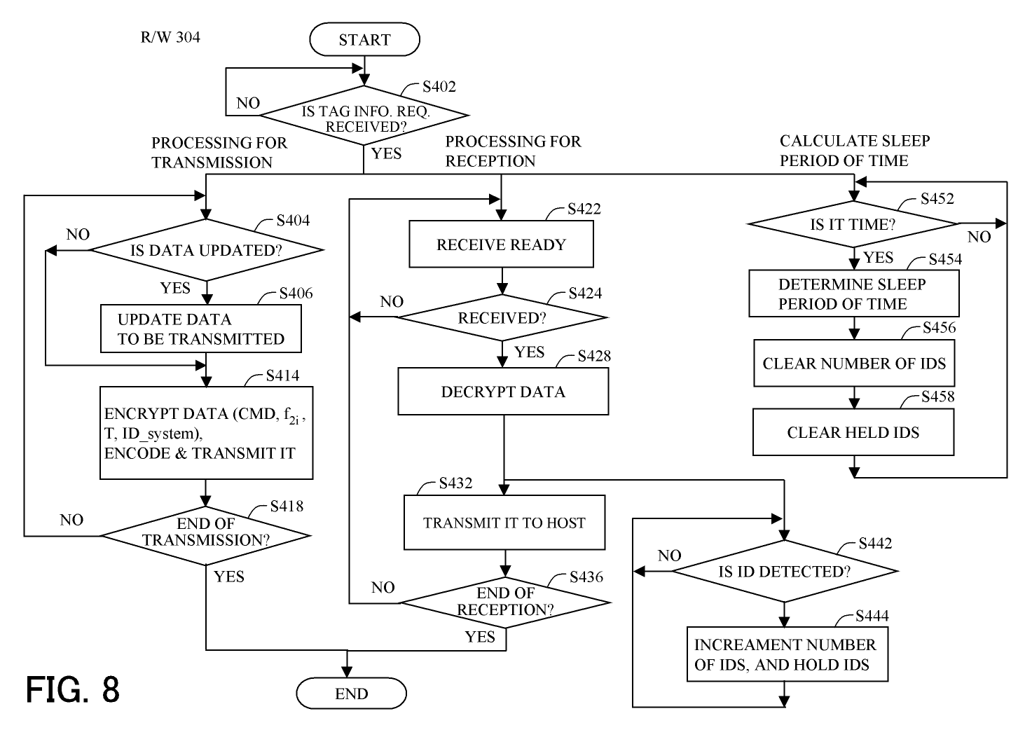

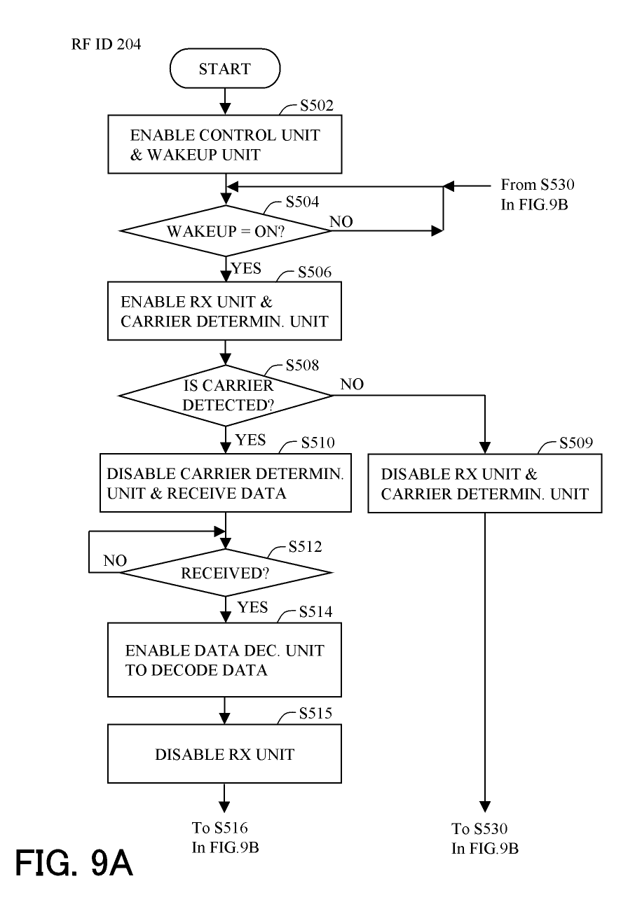

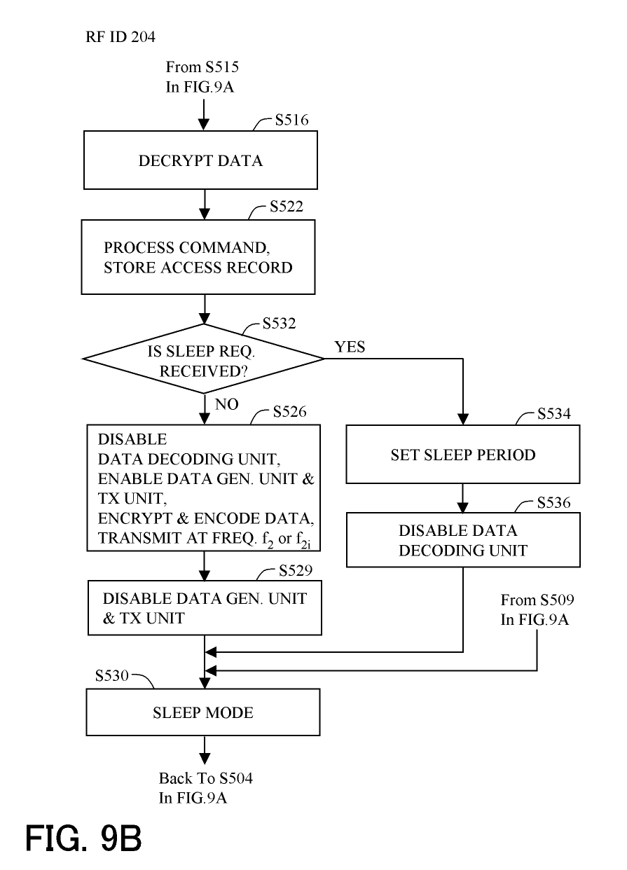

FIG. 8 illustrates an example of a flow chart for the processing performed by the reader and writer device 304. FIGS. 9A and 9B illustrate an example of a flow chart for the processing performed by the active-type RF ID tag 204. In FIGS. 8, 9A and 9B, the steps of the processing for authentication are not indicated for simplicity.

Referring to FIG. 8, Step 402 is similar to that of FIG. 3. For the processing for transmission, the control unit 310 of the reader and writer device 304 at Step 404 retrieves the data in the data hold unit 368 and determines whether the data in the data hold unit 368 has been updated. If it is determined that it has not been updated, the procedure proceeds to Step 414. If it is determined that it has been updated, the control unit 310 at Step 406 updates or causes the data generation unit 322 to update the transmission data so as to contain the data retrieved from the data hold unit 368 together with the new command and the like.

Steps 414 to 418 are similar to those of FIG. 3. In this example, the data generation unit 322 encrypts the tag information request command received from the control unit 310 and the data retrieved from the memory 314, and possibly the sleep request, the sleep period of time Tslp, and the tag ID, in accordance with the given cryptosystem. The data generation unit 322 then encodes the encrypted data in accordance with the given encoding scheme. Then, in the time periods of processing for transmission 42 or 43 to 45, the transmitter unit 330 modulates the carrier with the encoded data, and then transmits an RF signal at a frequency f₁.

Steps 422-436 for the processing for reception are similar to those of FIG. 3.

At Step 442 following Step 428, under the control of the control unit 310, the ID detector 362 of the sleep time period setter unit 360 detects a tag ID from the response data, and then determines whether it detects a new tag ID which is not held in the data hold unit 368. Step 442 is repeated until a new tag ID is detected. When it is determined that a new tag ID has been detected, an indication of increment “+1” is provided to the counter 366. The tag ID is then provided to the data hold unit 368. At Step 444, under the control of the control unit 310, the counter 364 increments its count by one (1). The data hold unit 368 then additionally holds the detected tag ID. Then, the procedure returns to Step 442. Steps 422 to 444 are continued until the processing for reception is completed.

For the calculation of the sleep period of time, at Step 452, the control unit 310 determines whether it is time to determine a sleep period of time, i.e., whether it has received the timing signal TM from the timer 374. Step 452 is repeated until the control unit 310 receives the timing signal TM. At Step 454, in response to the timing signal TM, the control unit 310 causes the sleep time period determiner 366 to read the count in the counter 364, and then determine the value of the sleep period of time Tslp in accordance with the particular formula or the table for determining a sleep period of time as illustrated in FIG. 11. At Step 456, the control unit 310 resets the counter 364 to clear the ID count (into 0). After that, the tag IDs in the data hold unit 368 and the count of the number of IDs are read by the data generation unit 322. After the tag IDs and the ID count are read by the data generation unit 322, the control unit 310 at Step 458 clears the held data (the tag IDs and the ID count) in the data hold unit 368. Then, the procedure returns to Step 452.

Referring to FIGS. 9A and 9B, Steps 502-530 performed by the RF ID tag 204 are similar to those of FIGS. 4A and 4B.

At Step 532 following Step 522, the control unit 210 of the RF ID tag 204 determines whether the received command CMD contains a sleep request and a value of the sleep period of time Tslp. If it is determined that it does not contain a sleep request, the procedure proceeds to Step 526. If it is determined that it contains a sleep request, the control unit 210 at Step 534 stores the sleep period of time Tslp in the memory 214 and sets the sleep period of time Tslp into the timer 274. The timer 274 counts or measures the time elapsing from the time of day at the start of receiving the command until the sleep period of time Tslp has elapsed. At Step 536, the control unit 210 disables the data decoding unit 242. Then, the procedure proceeds to Step 530.

At Step 530, the control unit 210 causes the RF ID tag 202 to enter into a sleep mode of operation. In the sleep mode of operation, basically only the control unit 210 and the wakeup unit 270 maintain to be in the enabled states, while the other elements 214 to 250 become disabled. In the sleep period of time Tslp, the wakeup unit 270 stops the counting of the number of the cycles Ts for sensing a carrier. When the elapsed time measured by the timer 274 from the time of day at the start of receiving the command from the reader and writer device 304 reaches the length of the sleep period of time Tslp, the wakeup unit 270 generates and then provides a wakeup signal to the control unit 210. In response, the cyclic carrier sensing restarts.

According to the embodiment described above, the reader and writer device can cause already read-out ones of a number of RF ID tags to enter into a sleep state for a particular period of time, so that it further reads the remaining RF ID tags within the sleep period of time. This avoids undesirable repeated reading of the same RF ID tags. Further, this avoids already read-out RF ID tags from interference with reading the remaining RF ID tags. Thus, all of the RF ID tags can be read in a relatively short time.

Simulation of determining time necessary to complete reading of all of the RF ID tags for the RF ID tags according to the embodiment (of FIG. 5) and the general RF ID tags (of FIG. 1) was conducted for the cycle Ts of sensing a carrier in the RF ID tags assumed to be one (1) second, the number of transmission slots in the RF ID tags assumed to be 100, the number of RF ID tags assumed to be 100, the sleep period of time Tslp set to be the number of received IDs divided by six (6) seconds (truncated at the decimal point).

According to the resultant simulation in accordance with the general method illustrated in FIGS. 1 to 4B, reading of 60% of the entire RF ID tags is completed at an elapsed time of the first 2 seconds. Further reading of 90% of the entire RF ID tags is completed at an elapsed time of 5 seconds. Still further reading of 99% of the entire RF ID tags is completed even at an elapsed time of 10 seconds.

According to the resultant simulation in accordance with the method of the embodiment illustrated in FIGS. 5 to 9B, reading of 37% of the entire RF ID tags is completed at an elapsed time of the first one (1) second, and a period of six (6) seconds is set up as the sleep period of time. Further reading of 71% of the entire RF ID tags is completed at an elapsed time of the two (2) seconds, and a period of five (5) seconds is set up as the sleep period of time. Still further reading of 93% of the entire RF ID tags is completed at an elapsed time of the three (3) seconds, and a period of three (3) seconds is set up as the sleep period of time. Still further reading of 99% of the entire RF ID tags is completed at an elapsed time of the four (4) seconds, and a period of one (1) second is set up as the sleep period of time. Still further reading of 100% of the entire RF ID tags is completed at an elapsed time of the five (5) seconds, and a period of zero (0) second is set up as the sleep period of time. In comparison between the times required for reading 99%, the time for reading according to the method of the embodiment can be reduced to half of the time according to the general method.

The invention may be applied, for example, to entry and exit management of persons in an office. In this case, each person may carry an RF ID tag, while a reader device may be installed at the gate of each room. Then, even when a number of persons pass the gate simultaneously, reading can be completed in a short time.

When a number of persons or articles each carrying an RF ID tag pass a plurality of gates one after another, each RF ID tag need return to a normal state of cyclic carrier sensing in a short time as soon as possible after the entry into a sleep mode of operation at one gate and before arrival at the next gate. Thus, if a common fixed sleep period of time is set up in all RF ID tags, the last RF ID tag read out at the one gate returns to a normal operation state at the last. This may cause the last RF ID tag not to return to the normal operation state before the arrival at the next gate. However, according to the embodiment, a shorter sleep period of time can be set up in an RF ID tag which is read out later. Thus, all of the RF ID tags can return to the normal operation states almost simultaneously. Accordingly, all of the RF ID tags can return to a normal operation state before the arrival at the next gate.

Although the embodiments have been described in connection with application to the RF ID tags, it should be understood by those skilled in the art that the invention is not limited to such RF ID tags and is also applicable to contactless IC cards.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information access system comprising:
a reader and writer device comprising:
a first memory,
a first control unit,
a first timing generator for measuring time,
a sleep time period setter unit for determining an identification carried by a response signal received in a period of time, and a length of a sleep period of time depending on a number of received identifications,
a first transmitter unit for repeatedly transmitting either one of an information request signal and an information and sleep request signal carrying a length of the sleep period of time and the received identification, at a first frequency in a time period of transmission, and
a first receiver unit for receiving a response signal carrying an identification at a second frequency which is different from the first frequency; and
a plurality of information storage devices, each comprising:
a second memory for storing an identification of that information storage device,
a second timing generator for measuring time,
a battery,
a second control unit,
a second receiver unit for sensing a carrier of an RF signal at the first frequency for detection, and further receiving the information request signal or the information and sleep request signal in response to detection of a carrier of an RF signal, and
a second transmitter unit for, in response to reception of the information request signal or the information and sleep request signal carrying no identification of that information storage device, transmitting a response signal carrying the identification of that information storage device at the second frequency, and, in response to the reception of the information and sleep request signal carrying the identification of that information storage device, being caused by the second control of the second control unit to be in an inactive state during the sleep period of time.

2. A contactless reader and writer device for reading and writing information in an information storage device in a contactless manner, comprising:
a memory;
a timing generator for measuring time;
a control unit;
a sleep time period setter unit for determining an identification carried by a response signal received from a contactless information storage device in a given period of time, and a length of a sleep period of time for the contactless information storage device depending on a number of received identifications;
a transmitter unit for repeatedly transmitting either one of an information request signal and an information and sleep request signal carrying a length of the sleep period of time and the received identification, at a first frequency in a time period of transmission; and
a receiver unit for receiving a response signal carrying an identification at a second frequency different from the first frequency that is transmitted by a contactless information storage device in response to the information request signal or the information and sleep request signal.

3. The contactless reader and writer device according to claim 2, wherein the sleep time period setter unit comprises:
a detector for detecting an identification carried by a received response signal;
a counter for counting a number of the detected identifications; and
a sleep time period determiner unit for determining the length of the sleep period of time depending on a count from the counter.

4. The contactless reader and writer device according to claim 2, wherein the given period of time is determined at a cyclic timing generated by the timing generator in accordance with a cycle period stored in the memory.

5. The contactless reader and writer device according to claim 3, wherein the given period of time is determined at a cyclic timing generated by the timing generator in accordance with a cycle period stored in the memory.

6. The contactless reader and writer device according to claim 2, wherein the given period of time has the same length as a cycle period of sensing a carrier in the contactless information storage device.

7. The contactless reader and writer device according to claim 2, wherein the length of the sleep period of time is determined in accordance with a table describing the lengths of the sleep period of time depending on the number of received identifications.

8. The contactless reader and writer device according to claim 3, wherein the length of the sleep period of time is determined in accordance with a table describing the lengths of the sleep period of time depending on the number of received identifications.

9. The contactless reader and writer device according to claim 2, wherein the length of the sleep period of time is determined in accordance with a formula as a function of the number of received identifications.

10. A contactless information storage device comprising:
a memory for storing an identification of the contactless information storage device;
a timing generator for measuring time;
a battery;
a control unit;
a receiver unit for sensing a carrier of an RF signal at a first frequency in a particular cycle for detection, and further receiving an information request signal or an information and sleep request signal in response to detection of a carrier of an RF signal; and
a transmitter unit for, in response to reception of the information request signal or the information and sleep request signal carrying no identification of the contactless information storage device, transmitting a response signal carrying the identification of the contactless information storage device at a second frequency different from the first frequency, and, in response to reception of the information and sleep request signal carrying the identification of the contactless information storage device, being caused by the control unit to be in an inactive state during the sleep period of time.

11. The contactless information storage device according to claim 10, wherein the transmitter unit transmits the response signal in a period selected at random.

12. The contactless information storage device according to claim 10, wherein the control unit controls the transmitter unit and the receiver unit to stay in an inactive state during the sleep period of time.

13. A machine-readable storage medium storing a program thereon for operating a contactless reader and writer device comprising a memory, a timing generator and a control unit and for reading and writing information in an information storage device, the program being operable to effect:
receiving a response signal carrying an identification at a second frequency different from the first frequency that is transmitted by a contactless information storage device;
detecting an identification carried by a response signal received from the contactless information storage device in a given period of time;
determining a length of a sleep period of time for the contactless information storage device depending on a number of received identifications; and
repeatedly transmitting either one of an information request signal and an information and sleep request signal carrying a length of the sleep period of time and the received identification, at the first frequency in a time period of transmission.

14. A machine-readable storage medium storing a program thereon for operating a contactless information storage device comprising a memory, a timing generator and a control unit, the program being operable to effect:
sensing a carrier of an RF signal at a first frequency in a particular cycle for detection;
receiving an information request signal or an information and sleep request signal in response to detection of a carrier of an RF signal;
in response to reception of the information request signal or the information and sleep request signal carrying no identification of the contactless information storage device, transmitting a response signal carrying the identification of the contactless information storage device at a second frequency different from the first frequency; and
in response to reception of the information and sleep request signal carrying the identification of the contactless information storage device, disabling the transmitting to be in an inactive state during the sleep period of time.

15. A method of operating a contactless reader and writer device comprising a control unit, a transmitter unit and a receiver unit, and for reading and writing information in an information storage device, the method comprising:
causing the receiver unit to receive a response signal carrying an identification at a second frequency different from the first frequency that is transmitted by a contactless information storage device;
causing the control unit to detect an identification carried by a response signal received from the contactless information storage device in a given period of time;
causing the control unit to determine a length of a sleep period of time for the contactless information storage device depending on a number of received identifications; and
causing the transmitter unit to repeatedly transmit either one of an information request signal and an information and sleep request signal carrying a length of the sleep period of time and the received identification, at the first frequency in a time period of transmission.
